(19) United States
(12) Patent Application Publication
(10) Pub. No.: US 2013/0328649 A1
(43) Pub. Date: Dec. 12, 2013

(54) DIVERGENT FLUX PATH MAGNETIC ACTUATOR AND DEVICES INCORPORATING THE SAME

(71) Applicant: Glen A. Robertson, Madison, AL (US)

(72) Inventor: Glen A. Robertson, Madison, AL (US)

(73) Assignee: Institute for Advanced Studies in the Space, Population & Energy Sciences

(21) Appl. No.: 13/489,638

(22) Filed: Jun. 6, 2012

(51) Int. Cl. H01F 7/08

(52) U.S. Cl. CPC H01F 7/08
USPC 335/234

(57) ABSTRACT

Divergent flux path magnetic actuation is a technique employed to move and magnetically hold an armature in electromechanical actuator devices. These actuators are typically used for linear and reciprocating application with a shaft firmly fixed to an armature or central pole piece to convey movement and forces. By incorporating a bearing about the shaft, rotation can also be conveyed. Further these actuators are more adaptable to energy saving applications than conventional solenoids, specifically when their control coils are parallel connected to reduce the input voltage from a power source and electrically pulsed from a capacitor to reduce the energy input. Thus divergent flux path magnetic actuators can be used for multipurpose energy saving applications and adapted to a variety of devices that would commonly use conventional solenoids.

### RELATED APPLICATIONS

Applications related to the foregoing applications include U.S. patent application entitled “PERMANENT MAGNET LATCHING SOLENOID,” having U.S. Pat. No. 6,265,956 B1, date Jul. 24, 2001; J.P. Patent entitled “SOLENOID ACTUATOR,” having U.S. Pat. No. 7,037,461, date 1995; U.S. Patent entitled “LATCHING SOLENOID WITH MANUAL OVERRIDE,” having U.S. Pat. No. 5,365,210, date Nov. 15, 1994; U.S. Patent entitled “ELECTROMAGNETIC DEVICE,” having U.S. Pat. No. 3,381,181, date Apr. 30, 1968; U.S. Patent entitled “VARIABLE LIFT OPERATION OF BISTABLE ELECTROMECHANICAL POPPET VALVE ACTUATOR,” having U.S. Pat. No. 4,829,947, date May 16, 1989, U.S. patent application entitled “SOLENOID OPERATED VALVE WITH MAGNETIC LATCH,” having U.S. Pat. No. 3,814,376, date Jun. 4, 1974; U.S. Patent entitled “DUAL POSITION LATCHING SOLENOID,” having U.S. Pat. No. 3,022,450, date Feb 20, 1962, the disclosures are hereby incorporated by reference.

### FIELD OF THE INVENTION

The present invention relates generally to the multipurpose use of divergent flux path magnetic actuators, examples include U.S. Pat. Nos. 3,022,450; 3,381,181; 5,365,210; 6,265,956 B1; 7,037,461, wherein the magnetic flux from a toroid or ring shaped radially poled permanent magnet with extended and bi-directional coaxial poles is directionally induced to divert its paths by control coils placed about the movable center pole or armature in order to magnetically attract the armature to closed pole ends of a magnetic body that typically comprises the outer housing for the purpose of producing mechanical linear or reciprocating force on attached devices through a shaft firmly fixed to the armature, and further shown here to transmit rotational force to attached devices through a shaft and bearing that is allow to move in the armature.

### BACKGROUND OF THE INVENTION

Divergent flux path magnetic actuation is a technique employed to move and magnetically hold an armature in electromechanical devices including some valves. The permanent magnets are employed in a manner that places their magnetic field in a bi-stable state to allow control coils to divert the magnetic field in one of two directions within the surrounding magnetic material. Examples of bi-stable permanent magnet actuators include U.S. Pat. Nos. 3,022,450; 3,381,181; 5,365,210; 6,265,956 B1; 7,037,461, each having a magnetic body incasing the permanent magnet, two controls coils, and moveable central pole piece or armature with the control coils placed one on either side of the permanent magnet and about the central pole piece. The control coils are connected to a power source and form a single current directional path to produce a single directional path magnetic field to divert the permanent magnet's magnetic field in one of two directions from the permanent magnet to bi-directionally attract the movable central pole piece to the fixed pole ends of the magnetic body as done in U.S. Pat. Nos. 3,022,450; 3,381,181; 5,365,210; 7,037,461; 6,265,956 B1.

### SUMMARY OF THE INVENTION

Divergent flux path magnetic actuators are:

Typically used for linear and reciprocating application with a shaft firmly fixed to the armature or central pole piece to convey movement and forces. By incorporating a bearing about the shaft, rotation can also be conveyed. It is then an object of the present invention to produce a divergent flux path magnetic actuator that can convey rotational motion.

More adaptable to energy saving applications than conventional solenoids, specifically when their control coils are parallel connected to reduce the input voltage from a power source and electrically pulsed from a capacitor to reduce the energy input. It is then an object of the present invention to show multipurpose energy saving applications for divergent flux path magnetic actuators adapted to a variety of devices that would commonly use conventional solenoids.

### BRIEF DESCRIPTION OF THE DRAWINGS

For a better understanding of the present invention, reference may be made to the accompanying drawings in which:

FIG. 1 is a perspective view of one embodiment of a divergent flux path magnetic actuator with one end removed for clarity;

FIGS. 2-3 are cross-sectional views of a divergent flux path magnetic actuator showing the different latching positions and showing the bi-directional magnetic flux paths;

FIGS. 4-5 show the parallel connection of the control coils in a divergent flux path magnetic actuator to reduce the voltage from the power source.

FIG. 6 shows one of many H-bridge designs that are uniquely capable for energizing the control coils in the present invention.

FIG. 7 shows one method of charging a capacitor to voltages greater than 9V, providing the power source for current discharged through the H-bridge of FIG. 6.

FIGS. 8-10 are current traces. FIG. 8 illustrates the current trace for a conventional solenoid actuator.

FIGS. 9-10 are current traces from two different versions of a divergent flux path magnetic actuator using the same capacitor/voltage setup and the method of FIGS. 4-7, where FIG. 9 shows an ideal current trace for minimum energy use and FIG. 10 shows that the capacitor/voltage setup was over designed for the versions of the divergent flux path magnetic actuator used.

FIGS. 11-12 show two divergent flux path magnetic actuators of FIG. 2-3 back to back to increase the actuation length and with a spring to help movement against any force from an attached device.

FIGS. 13-14 are cross-sectional views of FIGS. 2-3 showing one method of a divergent flux path magnetic actuator modified for use with a magnetic shaft.

FIGS. 15-16 are cross-sectional views of FIGS. 13-14 showing how a divergent flux path magnetic actuator can be modified for use in a spline shaft to disengage two rotating shafts.

FIGS. 17-18 show a representative spline shaft mating pattern for use in FIGS. 15-16.

FIGS. 19-22 show a divergent flux path magnetic actuator modified for a sealed or isolation systems. FIGS. 19-20 are cross-sectional views of FIGS. 2-3 showing how a divergent flux path magnetic actuator can be modified for use in a sealed or isolation system. FIGS. 21-22 show the two isolated pieces of the present invention of FIGS. 19-20 for better prospective view.

FIGS. 23-26 show a divergent flux path magnetic actuator used in a valve. FIGS. 23-24 are cross-sectional views of FIGS. 2-3 showing one method of a divergent flux path magnetic actuator for use in a valve. FIGS. 25-26 are cross-sectional views of FIGS. 19-22 showing one method of a divergent flux path magnetic actuator for use in a sealed valve.

FIGS. 27-28 are cross-sectional views of FIGS. 2-3 showing one method of a divergent flux path magnetic actuator for use in a pump.

FIGS. 29-30 are cross-sectional views of FIGS. 2-3 showing one method of a divergent flux path magnetic actuator for use in a relay or switch.

FIGS. 31-32 are cross-sectional views of FIGS. 2-3 showing one method of a divergent flux path magnetic actuator for use in a pulse tube cryo-cooler.

### DETAILED DESCRIPTION OF THE INVENTION

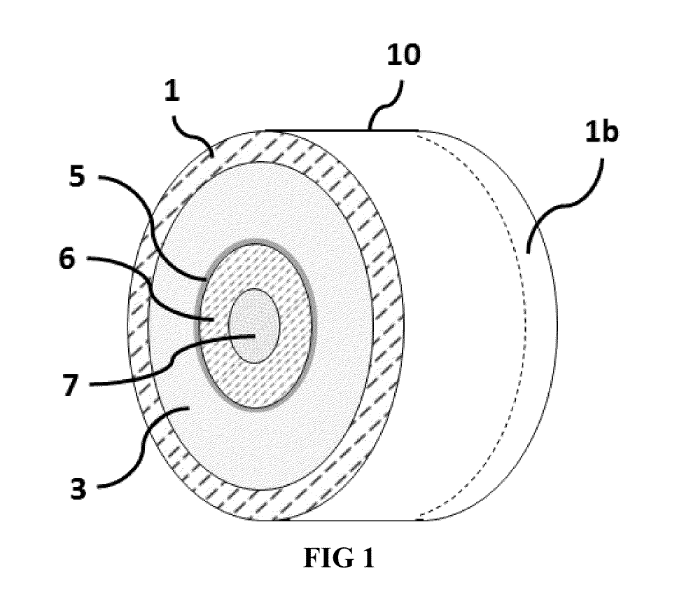

Referring now to the drawings, FIGS. 1-3 are provided to facilitate an understanding of the various aspects or features of a divergent flux path magnetic actuator. It is understood that multiple magnetic strength, shape and size divergent flux path actuators 10 are attainable using different magnetic strength, shape and size radial poled permanent magnets 2 with design suited for the modified devices as used throughout this specification. The radially poled permanent magnet 2 may be composed of any desirable permanent magnet material and may include radial extensions to the coaxial poles 1 and 6 using magnetic materials giving the desirable magnetic field and force characteristics needed for a given application. Multiple shapes and sizes of the radially poled permanent magnet 2 are attainable using different shape and size permanent magnets as toroid, square, rectangle or other geometric shapes that can be either one piece or composed of multiple pieces. Regardless of the shape and size radially poled permanent magnet 2, the radial poling direction of the permanent magnet is perpendicular to the cylindrical length, which can be either: north outward—south inward or south outward—north inward from a defined center of the permanent magnet. Poling parallel to the cylindrical length will not produce the desired results. The preferred poling direction as used throughout this specification is north inward as it produces the highest magnetic force given by the direction of the dark arrows.

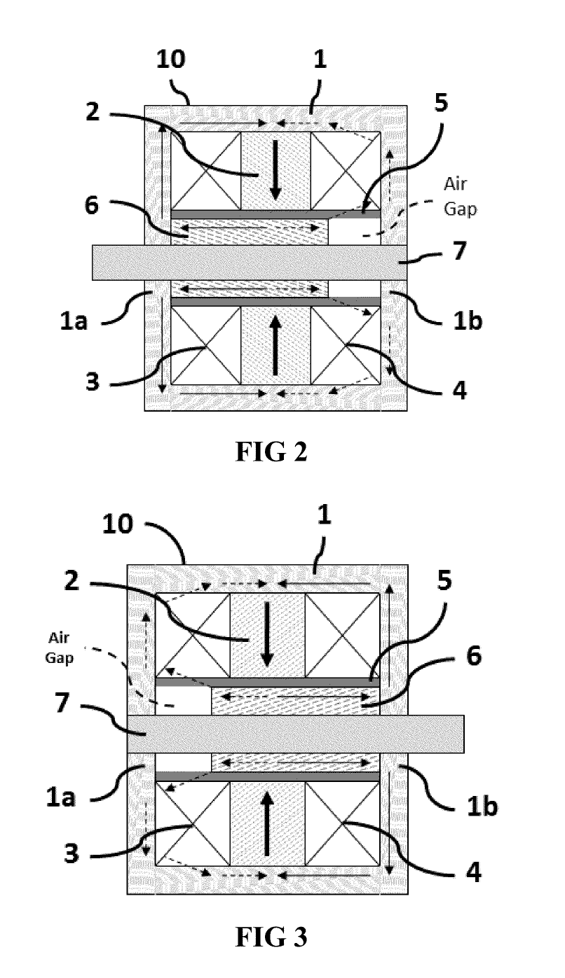

FIGS. 1-3 depict the cylindrical form of a divergent flux path magnetic actuator as used throughout this specification. FIG. 1 has attractor la removed for clarity. FIGS. 2-3 show the two positions of the armature 6 and non-magnetic shaft 7. In FIGS. 1-3, the permanent magnet 2 has a flat toroid shape and is poled radially with north inward of the toroid (dark arrow).

In FIGS. 1-3, the divergent flux path magnetic actuator 10 has a magnetic enclosure or housing 1 with firmly attached closed ends or attractors la and lb perpendicular to the length, and contains:

(a) A firmly fixed toroid or ring shaped radially poled permanent magnet 2 having concentric magnet pole faces,

(b) A firmly fixed pair of control coils 3 and 4 wound adjacent and on either side of the radially poled permanent magnet 2, wired to form a single solenoid like control coil with the same directional magnetic flux when energized,

(c) A thin non-magnetic tube 5 through the radially poled permanent magnet 2 and the control coils 3 and 4 extending between or through the attractors 1a and 1b of the magnetic housing 1,

(d) A magnetic armature 6, inside the non-magnetic tube 5, shorter than the distance between the attractors 1a and 1b to produce an air gap when against one of the attractors and free to move parallel to its length between the attractors 1a and 1b, and

(e) A shaft 7 centered inside and through the length of the armature 6 as not to degrade the function of the armature 6, preferably non-magnetic or designed to minimize the flux leakage between the permanent magnet 2 and the attractors 1a and 1b, extending through one or both of the attractors 1a and 1b of the magnetic housing 1, and can take on many different designs for transmitting linear, reciprocating or rotational forces.

In FIGS. 1-3, as used throughout this specification,

(a) The size of the air gap between an attractor 1a or 1b and one end of the armature 6 is a function of the design requirements of the magnetic actuator 10 needed for the application used,

(b) The maximum latching force attainable is a function of the permanent magnet's magnetic residual flux density (Br), magnetic flux leakage from the magnetic housing 1 and armature 6, and the facing areas of the armature 6 and an attractors 1a or 1b,

(c) The magnetic housing 1 and the armature 6, regardless of the shape or size, the preferably formed of soft iron, steel or some other magnetic material, with the preferred material being one which provides low reluctance, exhibits low hysterisis, and has a high magnetic flux density capability; likewise could be of laminate type construction.

(d) The method to firmly fix the permanent magnet 2, and control coils 3 and 4 inside the magnetic housing 1 and about the tube 5 can be through any means that does not take away from the functionality of the present invention.

(e) The leakage magnetic flux from the various components is disregarded for simplicity, but may need to be understood in various designs using the present invention.

As illustrated in FIG. 2, under no power to the control coils 3 and 4, the armature 6 is magnetically latched to the attractor 1a with the least air gap, whereby the magnetic flux (arrows) follows a radial path through the permanent magnet 2, bi-directionally through the armature 6 with the majority of the magnetic flux (solid arrows) in one direction through the attractor 1a and with the residual magnetic flux (dash arrow) being in the other direction through attractor 1b. In each direction, the magnetic flux (arrows) follows a path through the housing 1 back to the permanent magnet 2.

In reference to FIGS. 2-3, upon application of the proper power to the control coils 3 and 4 to reverse the direction of the primary magnetic flux from the permanent magnet 2 toward the attractor 1b, the armature 6 become more attracted to the attractor 1b moving toward attractor 1b to close the air gap.

As illustrated in FIG. 3, under no power to the control coils 3 and 4, the armature 6 is magnetically latched to the attractor 1b now having the least air gap, whereby the magnetic flux (arrows) follows a radial path through the permanent magnet 2, bi-directionally through the armature 6 with the majority of the magnetic flux (solid arrows) in one direction through the attractor 1b and with the residual magnetic flux (dash arrow) being in the other direction through attractor 1a. In each direction, the magnetic flux (arrows) follows a path through the housing 1 back to the permanent magnet 2.

### Control of the Coils

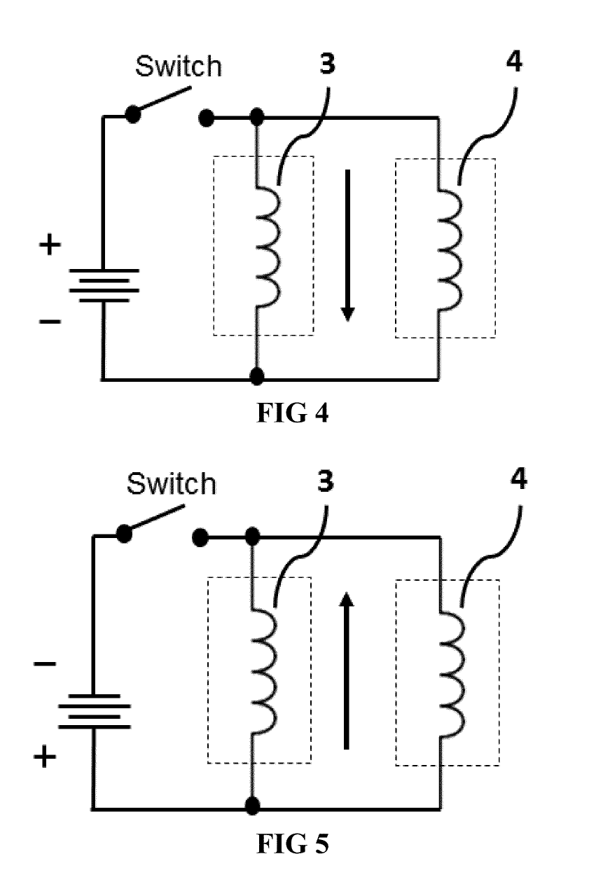

FIG. 4-5 shows the preferred parallel connection of the control coils 3 and 4, as used throughout this specification, to an alternating voltage/current source, where the arrow indicates the direction of the current through the coils when the switch is closed. It is understood that series connection can also be made, but will increase the total circuit resistance, requiring a higher voltage for a given pair of coils. In FIG. 4-5, the number of turns and the resistances of the control coils 3 and 4 are the same. The switching of the control coils voltage to reverse the current direction can be done with mechanical switches, relays or using various ICs or other methods as desired.

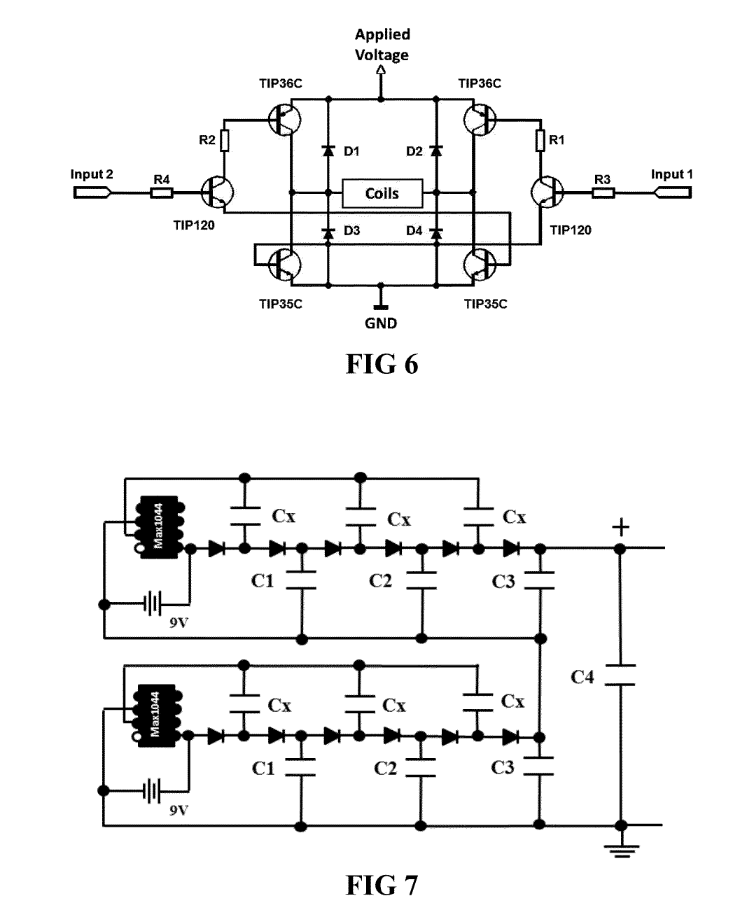

FIG. 6 shows one of many H-bridge designs, which is the preferred circuit to alternately energize the control coils pair 3 and 4 in a pulsed timed sequential manner to produce linear or bi-linear magnetic force between the armature 6 and the attractors la and lb to form a magnetic actuator for various applications. Connection of the control coils pairs 3 and 4 (represented by the word “Coils”) as shown in FIG. 6 allows single directionality of the magnetic flux in the armature 6 by applying a voltage to either “Input 1” or “Input 2” per standard H-bridge designs, which will energize the control coil pairs 3 and 4 in like current direction.

In FIG. 6, the Hi-bridge is defined by the TIP 36C/35C ICs with an Applied Voltage and ground (GND). The diodes D1-D4 are for back emf protection. For the TIP 36C/35C ICs, the resistors R1 and R2 are approximately 270 ohms. The TIP-120 ICs are used as they can be controlled with a 5V TTL signal from a computer for ease in operation. The resisters R3 and R4 may not be needed for a TTL signal from a computer, but may for direct connection to a voltage source. The inputs (1 and 2), Resisters (R3 and R4) and the TIP-120 ICs can be replaced with other types of switching methods provided they are pulsed in the proper manner as not to degrade the operation of the present invention.

In reference to FIGS. 2-3 and FIG. 6, when the proper voltage/current is applied to the proper input, either “Input 1” or “Input 2”, the permanent magnet-magnetic flux (solid arrows) is diverted through the armature 6 as defined by the direction of the magnetic flux (solid arrows) produced by the control coil pairs 3 and 4; reversing the voltage/current directions in sequence produces the opposite effect. For a given force, wire size, and number of coil turns, the pulsing time required to unlatch and attract the armature 6 to an attractor la or lb has been shown to decrease with increasing applied voltage. It has also been shown that increasing the voltage also allows for increased air gap distances. This allows for the development of divergent flux path electromagnets and magnetic actuators having variable reaction times and air gap distances with applied voltage.

FIG. 7 shows one of many low power capacitor charging circuits that can provide an impulse current through the H-bridge of FIG. 6 in order to reduce the energy input to the control coils pairs 3 and 4 providing for a highly energy efficient magnetic actuator. Per the MAX1044 data sheet, each voltage multiplier circuit produces 17V on capacitor “C1”, 25V on capacitor “C2” and 33V on capacitor “C3”. The series connection as shown between the two MAX1044 voltage multiplier circuits with independent 9V sources produced approximately 60V on capacitor “C4” during testing. Increased charging voltage can be achieved by series addition of more MAX1044 voltage multiplier circuits. Although adequate, the MAX1044 voltage multiplier circuit may be slow for some applications. For faster pulse rates, direct connection of the H-bridge to the power source or another type of faster charging voltage multiplier circuits should be used.

### Energy Efficient

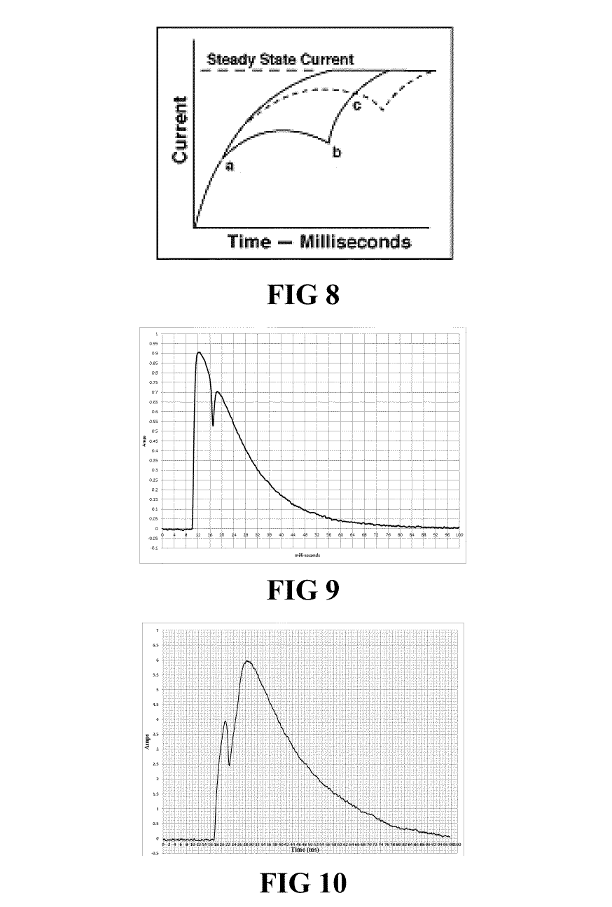

FIG. 8 illustrates the current trace for conventional magnetic actuators. When a DC voltage is impressed across the control coil, the current will rise to point (a), where the armature motion occurs as represented by the downward current to point (b), then the current moves along trace (c) to a “Steady State Current.” For a given conventional magnetic actuator, the rise time to point (a) is dependent upon the load, duty cycle, input power, stroke, and temperature range. This time delay, which occurs prior to the armature motion, is a function of the inductance and resistance of the coil, and the magnetic flux required to move the plunger.

FIGS. 9-10 are current traces from two different versions of the present invention using the same capacitor/voltage setup and the method of FIGS. 6-7, where FIG. 9 shows an ideal current trace for minimum energy usage and FIG. 10 shows that the capacitor/voltage setup was over designed for the version of the present invention used. In comparison to FIG. 8, the current traces, FIGS. 9-10, do not show a “Steady State Current” as once magnetically latched and the capacitor is discharged no more power is required. The absent of the “Steady State Current” represents a power savings over prior art. Dissipation of the energy from a capacitor then provides for a highly energy efficient replacement over the prior art of conventional electromagnets and magnetic actuators having a steady state current. The use of the over designed capacitor as shown in FIG. 10 may be required for systems with varying load, duty cycle, motion distance, input power, or temperature range.

It is noted that the smaller controls used in the present invention, decreases the time delay, which occurs prior to the armature motion. The time delay can be decreased further by increasing the voltage.

### Additional Force Mechanism

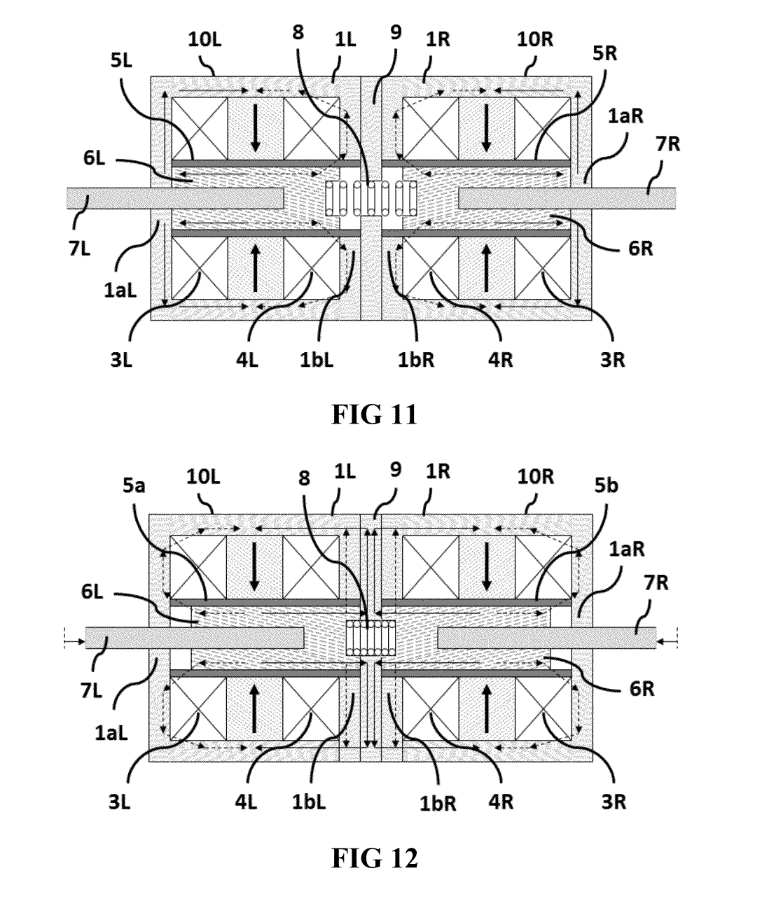

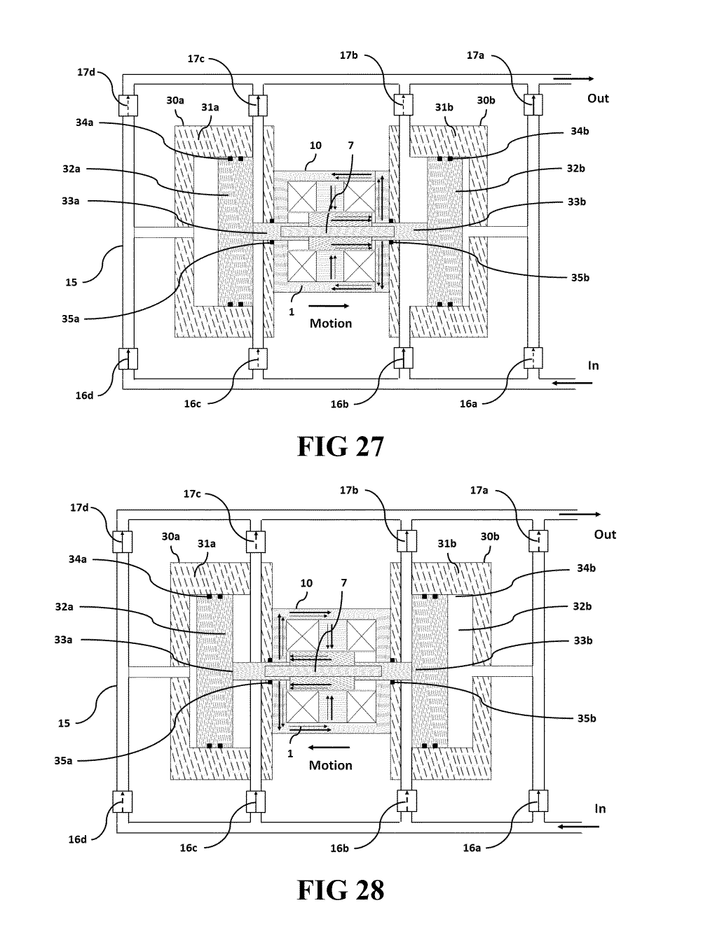

A divergent flux path magnetic actuator can be enhanced for greater linear motion distance, output force or increased electrical efficiency through the adaptation of other force mechanisms that do not require electrical power. Additional force mechanisms are demonstrate in FIGS. 11-12, where springs are used to aid in the motion of the actuators and, in FIGS. 27-28, where the input fluid/gas pressure aid in compressing the output fluid/gas, noting other non-electrical force mechanisms and methods can be used to enhance efficiency.

### Length Extension

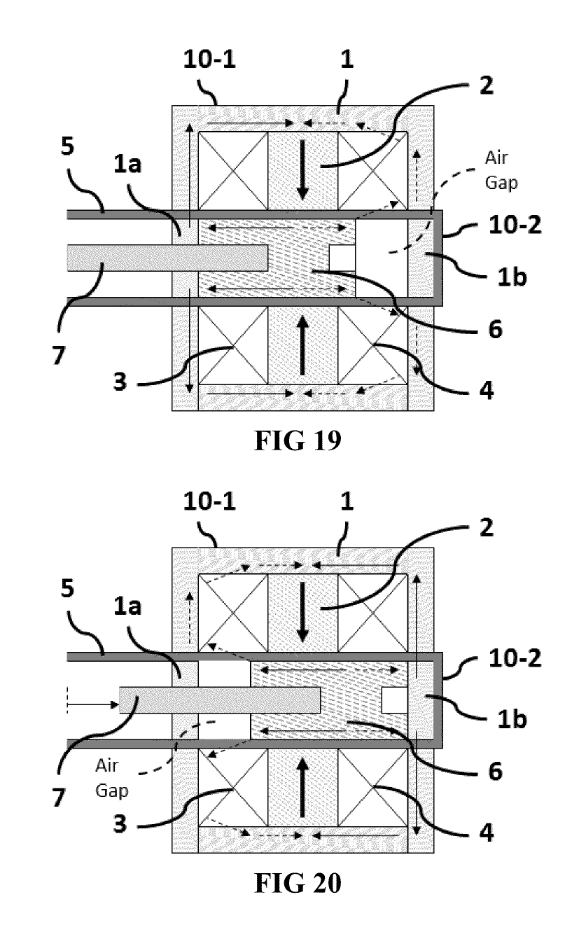

FIGS. 11-12 use two magnetic actuators 10L and 1OR (mirrored for ease of numbering) of FIGS. 2-3 to double the extension length of the shaft 7. In FIGS. 11-12, a spring 8 and a magnetic spacer 9 are placed between the two magnetic actuators 10L and 10R. The armatures 6L and 6R are recessed to center the spring 8 and to help the magnetic flux to reverse versa moving toward the center of the armatures 6L and 6R due to the absents of the non-magnet shafts 7a and 7b extruding outward to the spring 8. The non-magnetic tube 5L and 5R extends through the attractors 1bL and 1bR. Unlike the portion of the attractors 1bL and 1bR that would be inside the non-magnetic tube 5L and 5R in like to FIGS. 19-20, there is none. Instead the armatures 6L and 6R magnetically latch to the magnetic spacer 9 with some leakage to the attractors 1bL and 1bR. Under no power to the control coils 3L-4L and 3R-4R, the armatures 6L and 6R will remain magnetically latched to the attractors 1aL-1aR or 1bL-1bR with the least air gap, for example, attractor 1aL-1aR in FIG. 11 and attractor 1bL-1bR in FIG. 12. Directionally is controlled by energizing the control coils 3L-4L and 3R-4R in the proper manner to divert the flux in the armatures 6L and 6R toward the direction of the attractors 1aL-1aR or 1bL-1bR. In FIGS. 12, the arrow at the ends of the shafts 7a and 7b indicate the movement distance of the shafts 7a and 7b. The purpose of the spring 8 is to provide some coordination between the movement of the two armatures 6L and 6R and to give a quicker response time by overcoming any residual magnetic force quicker than without it.

### SHAFT DESIGN MODIFICATIONS

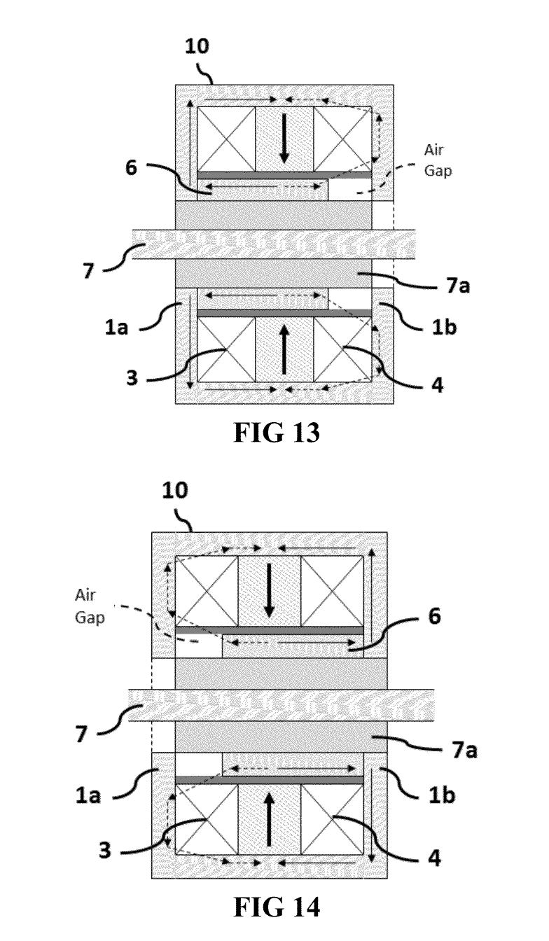

FIGS. 13-20 are presented to show various shaft designs. It is understood that other shaft design are possible.

### Magnetic Shaft

FIGS. 13-14 are cross-sectional views of the magnetic actuators 10 of FIGS. 2-3 showing one modification method for use with a magnetic shaft 7. In FIG. 13-14, a magnetic shaft 7 is surrounded and firmly attached to a non-magnetic material 7a, which is surrounded and firmly attached to the armature 6. The thickness of the non-magnetic material 7a, about the magnetic shaft 7 is such to minimize the leakage of magnetic flux from the armature 6. As with FIGS. 2-3, under no power to the control coils 3 and 4 the armature 6 will remain magnetically latched to the attractor 1a or 1b with the least air gap, for example, attractor 1a in FIG. 13 and attractor 1b in FIG. 14. Provide the non-magnetic material 7a and the magnetic shaft 7 is firmly attached to each other and the armature 6; they will move and latch accordingly.

### Rotating Shaft

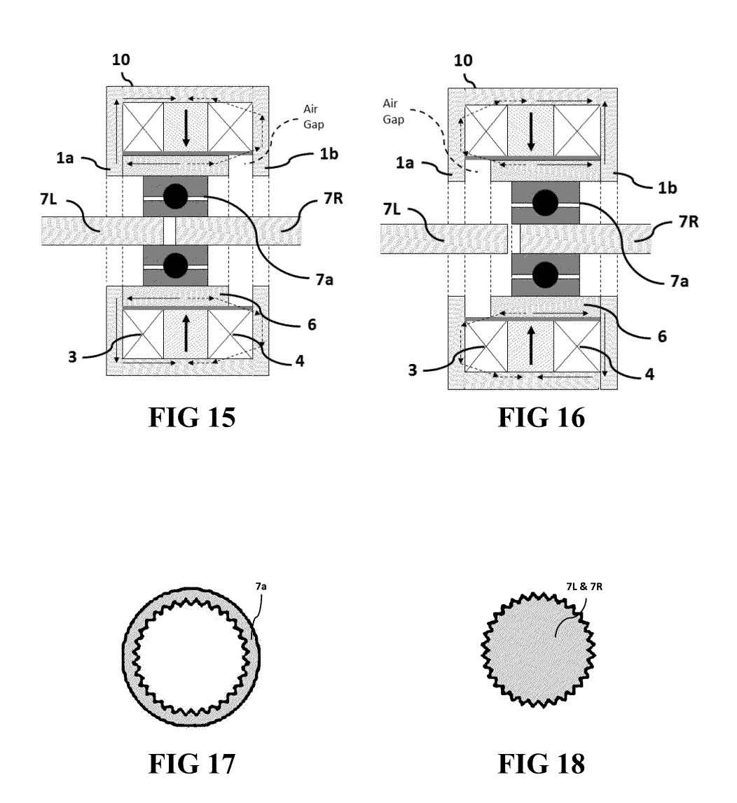

FIGS. 15-16 are cross-sectional views of the magnetic actuators 10 of FIGS. 3-14 showing one modification method for use to unite or disengage two rotating spline shafts 7L and 7R. In FIGS. 15-16, a bearing assembly 7a is placed inside and firmly attached to the armature 6. As with FIGS. 2-3, under no power to the control coils 3 and 4 the armature 6 will remain magnetically latched to the attractors 1a or 1b with the least air gap, for example, attractor 1a in FIG. 15 and attractor 1b in FIG. 16. Provided the bearing assembly 7a is firmly attached the armature 6, they will move and latch together, accordingly. The center bore of the bearing assembly 7a is splined in like to FIG. 17 and matched with FIG. 18. In FIG. 15, two spline matched shafts 7L and 7R in like to FIG. 18 are placed in the bearing assembly 7a. The two spline matched shafts 7L and 7R are attached (not shown) in a way that does not let them move with respect to the movement of the bearing assembly 7a. In FIGS. 15-16, the separation between the bearing assembly 7a and the shafts 7L and 7R to the attractors la or lb can be made wide enough to increase the magnetic flux resistance, such that the bearing assembly 7a and shaft 7L and 7R can be made from either non-magnetic or magnetic materials without reducing the holding force on the armature 6. The armature 6 may require a mechanism to keep it from rotating.

FIGS. 17-18 are reference spline (FIG. 17) and shaft (FIG. 18) teeth patterns, where the shape and number of teeth are design dependent. It is understood that:

a. The teeth pattern in FIG. 17 is though the center bore of the bearing 7a and the teeth pattern length in

FIG. 18 on the shafts 7L and 7R only needed to be long enough to inner the center bore of the bearing 7a to the appropriate functional length, and

b. The magnetic actuators 10 is firmly attract to both of the devices containing the shafts 7L and 7R, and that one device provides the proper function for producing rotational force and the other device provides the proper function for transferring the rotational force as needed.

### Isolated Shaft

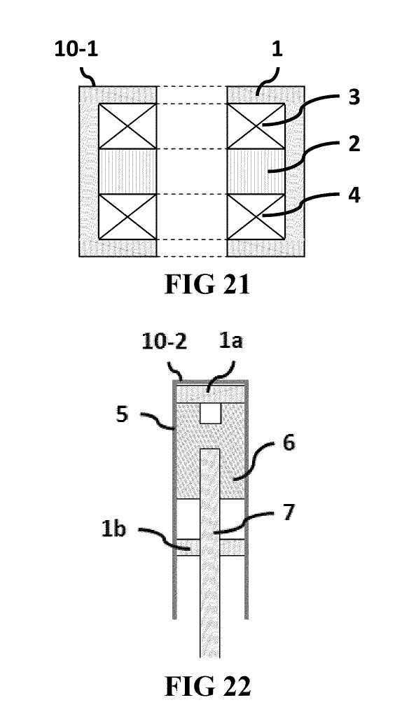

FIGS. 19-20 are modified versions of the magnetic actuator 10 of FIGS. 2-3 where pressure, fluid or other mediums could inner the present invention and need to be isolated by separating the magnetic actuator 10 into two isolated pieces, a main body 10-1 and a post 10-2. FIGS. 21-22 show the two isolated pieces, main body 10-1 and post 10-2, of the magnetic actuator 10 of FIGS. 19-20 for better prospective view, where the main body 10-1 is composed of the major portion of the housing 1, the control coils 3 and 4, and the permanent magnet 2 and where the post 10-2 is composed of the tube 5, armature 6, shaft 7, and portions of the attractors la and lb. It is understood that the tube 5 is non-magnetic and thin enough to allow the required magnetic flux from the permanent magnet 2 to cross it without functionally impairing the present invention.

In FIGS. 19-20, the tube 5 extends through the housing 1 with portions of the attractors 1a and 1b inside and firmly attached to the tube 5, spaced equally with the ends of the housing 1 forming the other portion of the attractors 1a and 1b. In FIGS. 19, 20 and 22, the armature 6 is recessed opposite the shaft 7, but it is preferred that the shaft 7 extend through the armature 6. The recess is shown to provide for a non-magnetic spring or force mechanism (not shown) to help aid in the motion or delatching, if needed. It is understood that another spring or force mechanism could be use on the opposite side of the armature 6 and on either side of the attractor 1a.

In FIGS. 19-22, the tube 5 is closed and sealed about a portion of the attractor 1b and the shaft 7 is firmly attached to the armature 6 from one end and extends only through the portion of attractor 1a. By extending the shaft 7 side of the tube 5 into a pressure, fluid or other medium chamber/vessel with proper sealing, isolation from the main body 10-1 is achieved similar to the way conventional magnetic actuators are isolated. Under no power to the control coils 3 and 4, the armature 6 will remain magnetically latched to the portions of the attractor 1a or 1b with the least air gap, for example, attractor 1a in FIG. 19 and attractor 1b in FIG. 20. In FIGS. 20, the arrow at the end of the shaft 7 indicates the movement distance of the shaft 7.

### INCORPORATING DEVICES

### Flow Valve

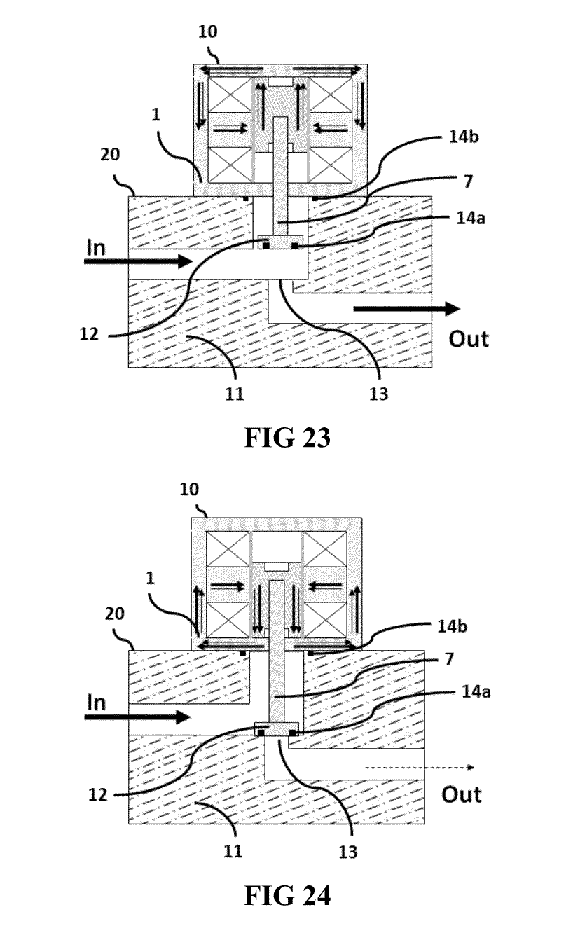

FIGS. 23-24 show a simple flow valve incorporating the magnetic actuator 10 of FIGS. 2-3 connected to a flow body 20, where FIG. 23 shows the valve stem 12 closed against the valve seat area 13 and FIG. 24 shows the valve stem 12 open or lifted off the valve seat area 13 due to the movement of the valve stem or shaft 7 of the magnetic actuator 10. In FIGS. 23-24, the flow valve is appropriately designed with a flow body 11 of a given material for gas or liquid flow and incorporates: an in and out flow path as indicated by the (In and Out) arrows, a value stem 12, a valve seat area 13 with pressure seal 14a connected to the valve stem seat 12 to create a firm seal when closed, as shown in FIG. 22, and a pressure/leak seal 14b between the flow body 11 and magnetic actuator 10 to create a firm pressure/leak seal when connected. As used in FIGS. 23-24, the valve stem seat 12, regardless of the shape, size or material composition, is firmly connected to the shaft 7 of the magnetic actuator 10, passing through the housing 1 of the magnetic actuator 10 and into the flow body 11. In FIGS. 23-24, the darker arrows represent flow/pressure and the dash arrow representing no-flow.

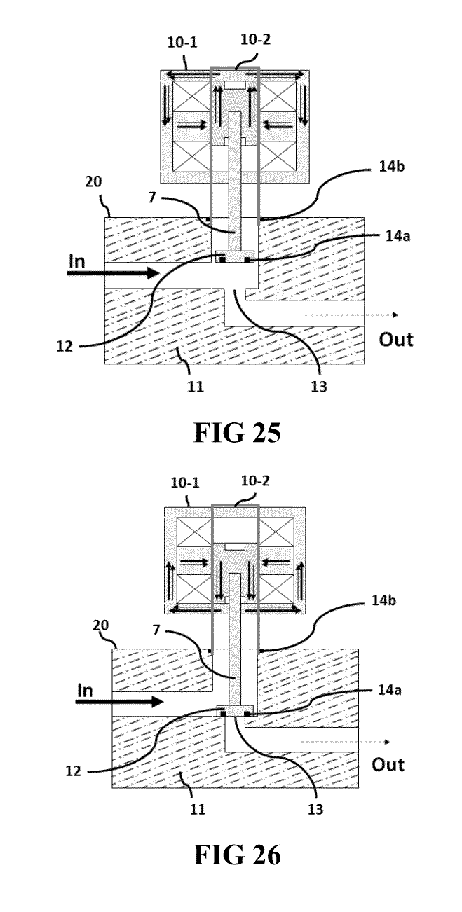

FIGS. 25-26 shows the isolation magnetic actuator of FIGS. 19-20 used with the flow valve body 20 with the respective parts of FIGS. 23-24 and defined above, where isolation of pressure, fluid or other mediums is needed. In FIGS. 25-26 the main body 10-1 is placed about the post 10-2 and one end of the post 10-2 is attached to the valve body 20 and sealed with an appropriate sealing method 14b. The valve operation is the same as defined above for FIGS. 23-24.

### Pump

FIGS. 27-28 show a simple pump incorporating the magnetic actuator 10 of FIGS. 2-3 to illustrate reciprocating motion. The magnetic actuator 10 through the housing 1 is connected to the pump 30a and 30b through the pump housing 31a and 31b and pressure sealed using O-rings 35a and 35b. The pump housings 31a and 31b, flow paths 15 with input check valves 16a, 16b, 16c and 16d and output check valves 17a, 17b, 17c and 17d, connection members 33a and 33b, and pistons 32a and 32b with seals 34a and 34b are appropriately designed for gas or liquid flow. The connection members 33a and 33b, regardless of the shape, size or material composition, is connected to the shaft 7 of the magnetic actuator 10.

FIG. 27 shows the pistons 32a and 32b moving to the right and FIG. 28 shows the pistons 32a and 32b moving to the left.

In FIGS. 27-28, it is understood that:

(a) The dark arrows at the in and out positions represent in and out flow,

(b) Flow through the input check valves 16a, 16b, 16c and 16d, and output check valves 17a, 17b, 17c and 17d are indicated by bold arrows and restricted or non-flow is indicated by the dashed arrow,

(c) The flow through the input check valves 16a, 16b, 16c and 16d, and output check valves 17a, 17b, 17c and 17d are defined by the pressure in the flow paths 15 with respect to the deferential produced across a check valve by the pistons 32a and 32b, and

(d) Regardless of the directional motion of the shaft 7 of the magnetic actuator 10, in and out flow is in the same direction with higher output pressure than the input pressure due to the pumping action during operation.

### Electrical Relay

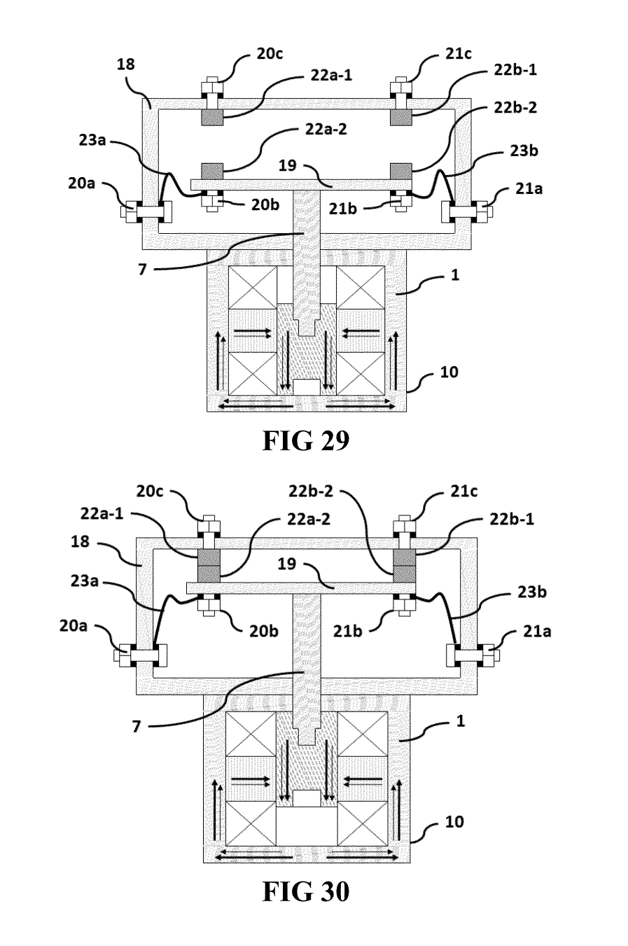

FIGS. 29-30 show a simple electrical relay incorporating the magnetic actuator 10 of FIGS. 2-3 to illustrate utility for remote operation of devices in similar manner The magnetic actuator 10 is firmly connected through the housing 1 to a non-electrical conductive relay housing 18 containing input terminals 20a and 21a, intermediate terminals 20b and 21b, output terminals 20c and 21c, non-electrically conductive plate 19, connection wires 23a and 23b and contacts 22a-1, 22a-2, 22b-1 and 22b-2. Connection terminals 20b and 21b are mounted on the non-electrically conductive plate 19 and connection wire 23a electrically connects input terminals 20a and intermediate terminals 20b, and connection wire 23b electrically connects input terminals 21a and intermediate terminals 21b to allow movement of the plate 19. The plate 19 is connected firmly to the shaft 7 of the magnetic actuator 10.

FIG. 29 shows the relay open with no contact between the contacts 22a-1 and 22a-2 and no contact between the contacts 22b-1 and 22b-2, allowing no current path between the input terminals 20a and 21a and output terminals 20c and 21c, respectfully.

FIG. 30 shows the relay closed with contact between the contacts 22a-1 and 22a-2 and contact between the contacts 22b-1 and 22b-2, allowing a current path between the input terminals 20a and 21a and output terminals 20c and 21c, respectfully.

### Pulse Tube Cryo-Cooler

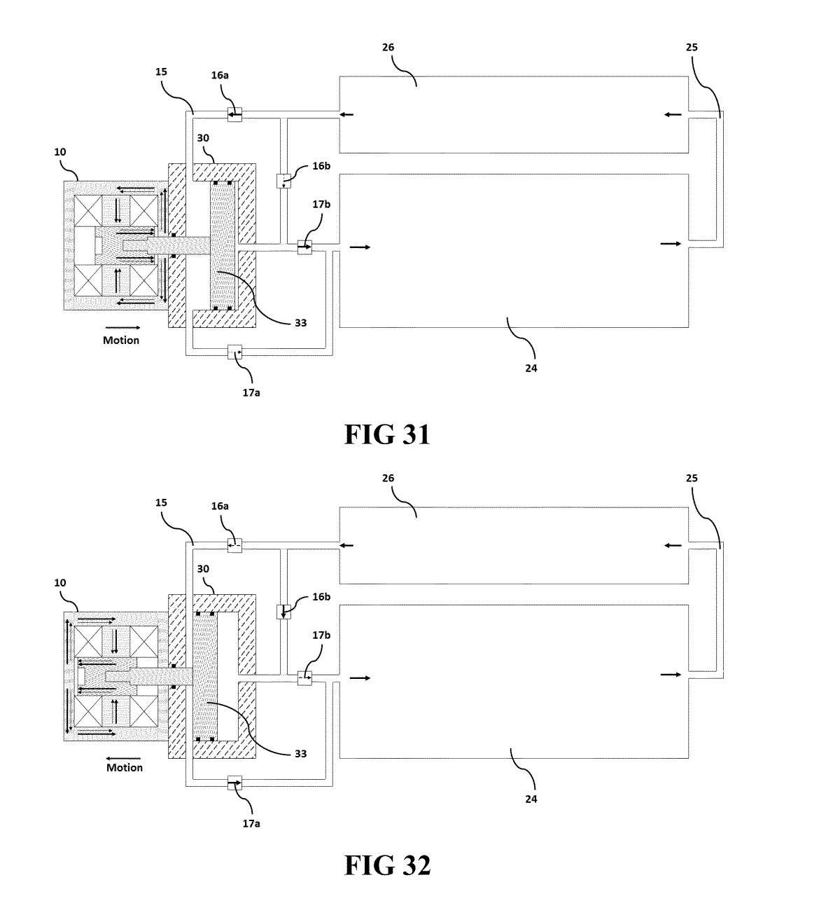

FIGS. 31-32 show the magnetic actuator 10 of FIGS. 2-3 attached to the pump 30 to compress a gas through a simple pulsed tube refrigerator (examples are: U.S. Pat. No. 3,237,421, U.S. Pat. No. 3,817,044, U.S. Pat. No. 5,295,355, U.S. Pat. No. 7,131,276). The pulsed tube refrigerator incorporates flow paths 15 with input check valves 17a and 17d and return put check valves 16a and 16b from the pump 30 to the regenerator 24 and pulse tube 26. The regenerator 24 and pulse tube 26 are connected to the cold head 25 having a flow path between them. The check valves 16a, 16b, 17a and 17b open/closed in a proper order to allow flow from the pump 30 and into the regenerator 24, cold head 25 and pulse tube 26 in a single direction, regardless of the direction of the electrical power applied to the magnetic actuator 10. FIG. 31 shows the piston 33 moving to the right and FIG. 32 shows the piston 33 moving to the left. As used in FIGS. 31 and 32, it is understood that the pump 30 operates like the pumps 30a and 30b in FIGS. 27-28.

1. (canceled)

2. Two or more electromagnetic devices comprising a divergent flux path magnetic actuator connected in a linear manner to extend the motion distance of the armature.

3. An electromagnetic device comprising a divergent flux path magnetic actuator, wherein the shaft is two pieces with the two pieces forming mating feature or spline.

4. An electromagnetic device comprising a divergent flux path magnetic actuator wherein a non-magnetic material is firmly place between the armature and the shaft to convey forces between the armature and shaft for allowance of a magnetic shaft without great magnetic flux loss in the magnetic pole pieces.

5. (canceled)

6. An electromagnetic device as set forth in claim 17 wherein the tube is not fixed, and the tube containing the armature, shaft and portions of the pole ends are removable as one unit from the device.

7. (canceled)

8. (canceled)

9. An electromagnetic device as set forth in claim 2, 3, 4, 6, 17, or 18 incorporated into a valve for the control of gases and fluids.

10. An electromagnetic device, comprising a divergent flux path magnetic actuator, or as set forth in claim 2, 3, 4, 6, 17, or 18 incorporated into a reciprocating pump for pumping or pressurizing gases or fluids.

11. An electromagnetic device, comprising a divergent flux path magnetic actuator, or as set forth in claim 2, 3, 4, 6, 17, or 18 incorporated into an electrical relay.

12. An electromagnetic device, comprising a divergent flux path magnetic actuator, or as set forth in claim 2, 3, 4, 6, 17, or 18 incorporated into a cryo-cooler to pump gases for producing refrigerated environments.

13. An electromagnetic device as set forth in claim 2, 3, 4, 6, 17, or 18 for various mechanical applications.

14. (canceled)

15. An electromagnetic device as set forth in claim 2, 3, 4, 6, 17, or 18 wherein an additional force mechanism is added to aid in the amount of travel or force produced by the device.

16. (canceled)

17. An electromagnetic device comprising a divergent flux path magnetic actuator, wherein a fixed tube composed of a thin non magnetic material is placed about the moveable center pole piece or armature with length between the pole ends of the magnetic body to allow free movement of the armature.

18. An electromagnetic device comprising a divergent flux path magnetic actuator, wherein a bearing or bushing is place between the armature and the shaft to allow the shaft to rotate.
